(19) United States
(12) Patent Application Publication
(10) Pub. No.: US 2003/0064620 A1
(43) Pub. Date: Apr. 3, 2003

(54) SOCKET ON A PRINTED CIRCUIT BOARD

(76) Inventor: Feng-Chien Hsu, Hsinchuang City (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 09/968,637

(22) Filed: Oct. 1, 2001

(51) Int. Cl. H01R 12/00

(52) U.S. Cl. 439/342

(57) ABSTRACT

A socket on a printed circuit board has a plurality of apertures. The apertures each have two first stops respectively formed on opposite inner walls, two recesses respectively defined beneath the first stops, and a second stop formed on an inner wall between the first stops. A plurality of connecting strips is respectively inserted in the apertures. The connecting strips each have an upright part. Two protrusions are respectively formed at two opposite sides of the upright part and received in the recesses and blocked by the first stops. A lateral part is formed at the bottom of the upright part and blocked by the second stop. A neck is formed near the top of the upright part, extends upward from the upright part and bent toward the lateral part. A head is formed at the top of the neck and bent away from the lateral part.

### BACKGROUND OF THE INVENTION

1. Field of the Invention

The present invention is related to a socket on a printed circuit board, and more particularly to a connecting strip in the socket.

2. Description of Related Art

In general, a CPU is detachably mounted in a socket on a main board of a computer. The socket is integrated with the main board and has a plurality of apertures in which pins of the CPU are inserted. A connecting strip is mounted in each aperture and is electrically connected to a CPU pin. Conventional connecting strips are inserted into the apertures through the ends of the apertures corresponding to the mounted chip and are held in position by fastening means in the apertures. However, when a CPU is removed from the socket, the conventional connecting strips may remain attached to the CPU pins and be pulled out through the upper ends of the apertures.

The invention provides an improved connecting strip for a socket to mitigate and/or obviate the aforementioned problem.

### SUMMARY OF THE INVENTION

The main objective of the invention is to provide a socket in which connecting strips are securely mounted.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a connecting strip in accordance with the invention;

FIG. 2 is a partially exploded perspective view of the connecting strip in FIG. 1 and a socket;

FIG. 3 is a side view in partial section of the connecting strip in FIG. 1 in an aperture of the socket;

FIG. 4 is an operational side view in partial section of the connecting strip in FIG. 1 with a pin of a CPU in the socket in electrical contact with the connecting strip; and

FIG. 5 is a top view of the connecting strip in FIG. 3.

### DESCRIPTION OF THE PREFERRED EMBODIMENT

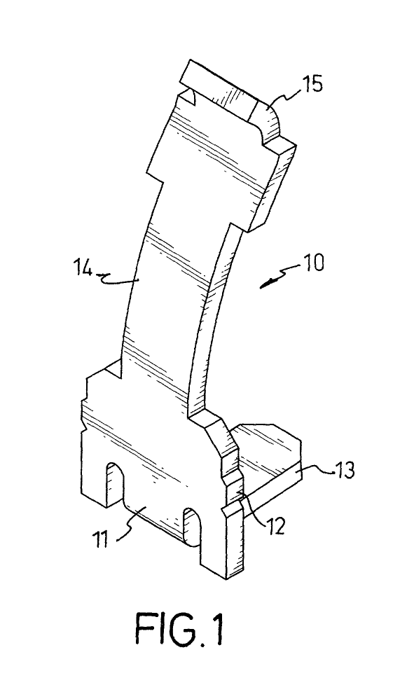

With reference to FIG. 1, a connecting strip (10) in accordance with the present invention is L-shaped and can be made of a sheet metal by punching.

The connecting strip (10) has a top, a bottom, an upright part (11) and a lateral part (13) formed at the bottom of the upright (11). Two protrusions (12) are respectively formed on opposite sides of the bottom of the upright part (11). The upright part (11) has a neck (14) formed toward the top, extends upwards and bents toward the lateral part (13). A head (15) is formed at the top of the neck (14) and bents away from the lateral part (13).

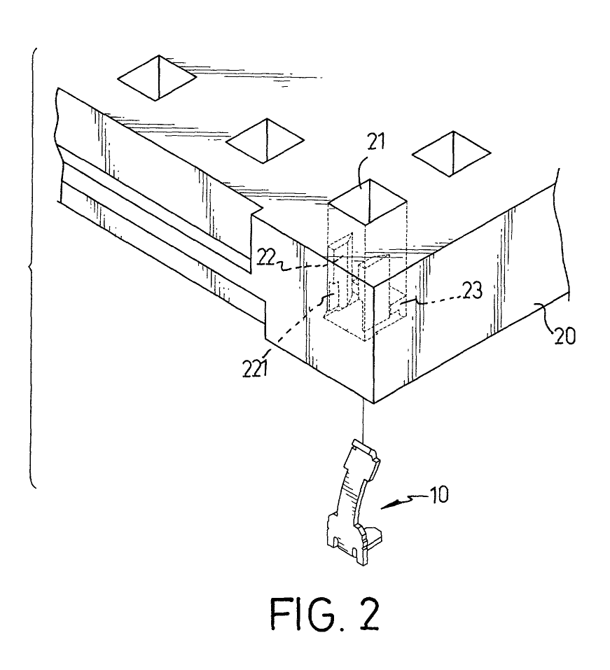

With reference to FIG. 2, a socket (20) has a plurality of apertures (21) defined through the socket (20). Each aperture (21) has a top, a bottom, four inner walls and two first stops (22) respectively formed on opposite inner walls of the aperture (21). Two recesses (221) are respectively defined beneath the first stops (22). A second stop (23) is formed on an inner wall between the opposite inner walls on which the first stops (22) are formed.

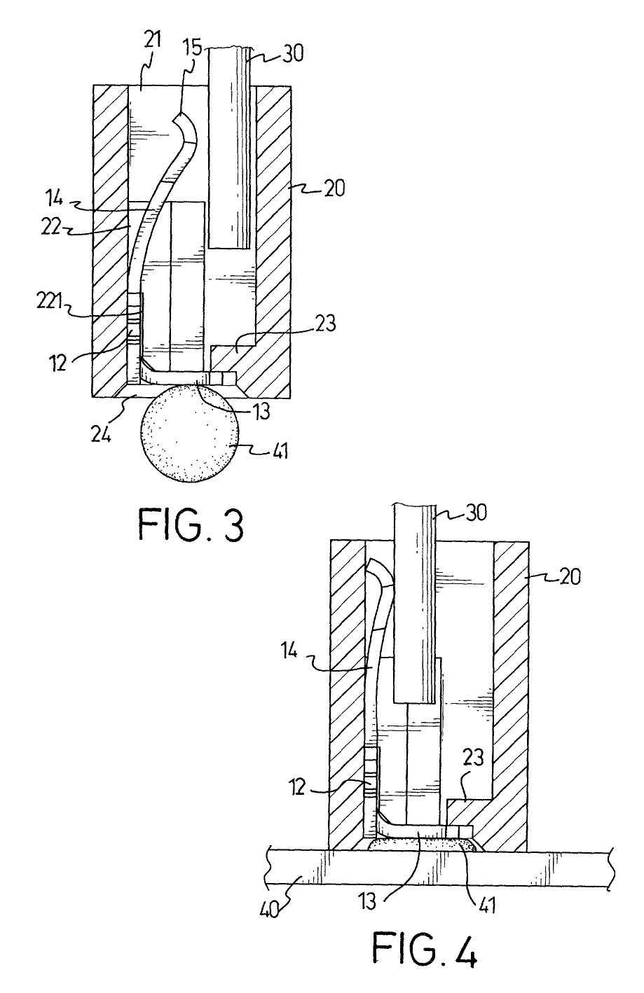

With reference to FIG. 3, the connecting strip (10) is inserted into the aperture (21) through the bottom of the aperture (21). The protrusions (12) are respectively received in the recesses (221) and are blocked by the first stops (22). The lateral part (13) is blocked by the second stop (23). A solder ball (41) is formed under the lateral part (13) of connecting strip (10). The socket (20) is bonded to a printed circuit board (40) by melting the solder ball (41), and the connecting strip (10) is electrically connected to a circuit on the main board (40), as shown in FIG. 4.

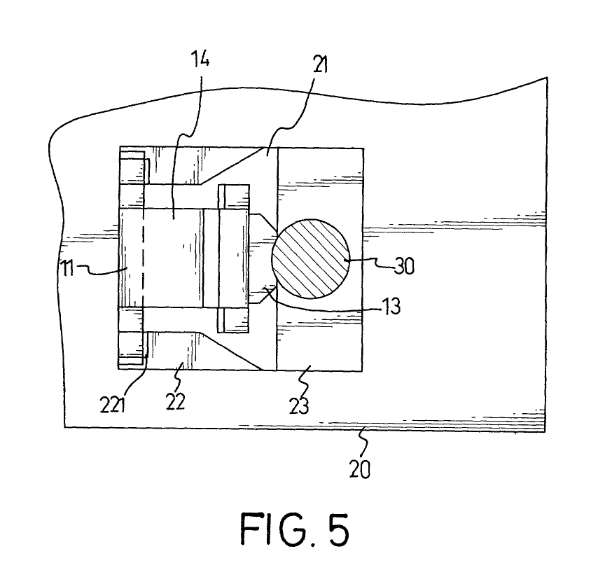

With reference to FIGS. 3-5, when a pin (30) of an electronic element such as a CPU is inserted in the aperture (21), the pin (30) is first located between the connecting strip (10) and an inner wall of the aperture (21). After the pins (30) have been inserted into the appropriate apertures (21), a fastening means (not shown) on the socket (20) moves the element and the pins (30) toward the corresponding connecting strips (10) causing the pins (30) to press against the connecting strips (10). With the pins (30) pressed against the connecting strips (10), the pins (30) are electrically connected to the heads (15) of the connecting strips (10).

Because the connecting strip (10) is inserted into the socket (20) through the bottom of the aperture (21) and secured to the printed circuit board (40) by the solder ball (41), the connecting strip (10) will not be pulled out of the aperture (21) when the CPU is removed from the socket (20).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the fill extent indicated by the broad general meaning of the terms in which the appended claims are expressed.

What is claimed is:

1. A socket (20) on a printed circuit board, the socket comprising:
a plurality of apertures (21), the apertures (21) each having four inner walls, two first stops (22) respectively formed on opposite inner walls, two recesses (221) respectively defined beneath the first stops (22), and a second stop (23) formed on an inner wall between the opposite inner walls on which the first stops are formed; and
a plurality of connecting strips (10) respectively inserted in the apertures (21) through a bottom end of the aperture (21), the connecting strips each having a top and a bottom, an upright part (11); two protrusions (12) respectively formed at two opposite sides of the upright part (11) and received in the recesses (221) and blocked by the first stops (22); a lateral part (13) formed at the bottom of the upright part (11) and blocked by the second stop (23); a neck (14) formed near the top of the upright part (11), extending upward from the upright part (11) and bent toward the lateral part (13); and a head (15) formed at the top of the neck (14) and bent outward away from the lateral part (13).

2. The socket as claimed in claim 1, wherein the connecting strips (10) each have a solder ball (41) formed under the lateral part (13) and to bond the socket on a printed circuit board by melting the solder ball (11).
